(19) United States
(12) Patent Application Publication
(10) Pub. No.: US 2003/0040965 A1
(43) Pub. Date: Feb. 27, 2003

(54) Method and device for rendering a content item

(76) Inventor: Johan Hendrik Antoon Gelissen, Eindhoven (NL)

Correspondence Address: Michael E. Marion, U.S. Philips Corporation, 580 White Plains Road, Tarrytown, NY, 10591, US

(21) Appl. No.: 10/222,236

(22) Filed: Aug. 16, 2002

(30) Foreign Application Priority Data
Aug. 22, 2001 (EP) 01203164.7

(51) Int. Cl. G06F 17/60; H04N 7/025; H04N 7/10

(52) U.S. Cl. 705/14; 725/32

(57) ABSTRACT

A method of and a device (100) for rendering a content item containing at least one advertisement. After confirming that the user has actively observed the at least one advertisement, the user is awarded a credit for said observing. If the user collects enough credits, he is given access to additional content material associated with the content item in return for a number of awarded credits. The credits are invalidated when rendering of the content item is complete. This gives users an incentive to collect a sufficient number of credits to access the additional content material before it is too late.

The invention relates to a method of rendering a content item containing at least one advertisement to a user, comprising confirming that the user has observed the at least one advertisement and awarding the user a credit for said observing.

The invention further relates to a device arranged for rendering a content item containing at least one advertisement to a user, comprising confirmation means for confirming that the user has observed the at least one advertisement and credit means for awarding the user credit for said observing.

The method according to the preamble is known from Research Disclosure 437008, September 2000. Content items, such as television programs, movies and the likes, often contain one or more advertisements or commercials. When the content item is being rendered to a user, for example by displaying it on his television system, the user is also exposed to the advertisement. The distributor of the content item receives money from advertisers in return for imbedding the advertisement in the content item.

It is well known that users do not like to see advertisements during their television programs or movies. In order to reduce this dislike, many so-called incentive programs have been developed, in which a user gets a reward of some kind in return for actively viewing the advertisement. The reward is typically a credit of some kind, for example a number of Air Miles or other points for use in a bonus system. The credits may also be tied to the advertised product, i.e. the credit gives a discount when buying the advertised product.

Confirming that the user has observed the advertisement can be done in a variety of ways. For example the user can be asked to press a particular button during or after the rendering of the advertisement, which proves that he has viewed the advertisement. The method according to the above-mentioned Research Disclosure embeds a code in the advertisement contained in the content item to signal the presence of the advertisement to the television. When the television detects the code, the user can place a card in the receiver connected to the television, and if the commercial is then shown on the television at normal speed, volume an so on, the credit is added to the card. The card can be ejected after a number of advertisements, to ensure that the user must actively re-insert the card after each advertisement so that it is very likely that he also actively views the advertisement.

While such incentive programs do encourage users to view advertisements, their effect is relatively small because of the generic nature of the credits or rewards. Since the credits are often used in a larger incentive program, such as the Air Miles system, only a relatively small amount of credits can be awarded for viewing an advertisement, which reduces the effectiveness of the incentive. Further, there is nothing that encourages the user to view multiple advertisements in one particular content item. Once he has collected a number of credits, he may decide to stop viewing advertisements until the next day or the next show. This makes the incentive scheme less attractive for advertisers whose advertisements are placed towards the end of the content item.

It is an object of the invention to provide a method according to the preamble, which is more effective than the prior art method.

This object is achieved according to the invention in a method which is characterized by giving the user access to additional content material associated with the content item in return for a number of awarded credits. The additional content material preferably comprises materials such as a 3-D model of at least one object present in the content item, a game associated with the content item, background information on the content item, or a clue for a question posed in the content item. Such additional content material is desirable for many viewers, and so they are encouraged to collect the necessary credits to access the additional content material. This means that they have to actively view a number of advertisements contained in the content item so as to be awarded these credits. Not only that, but they must also be awarded these credits before the content item ends, otherwise the additional content material will also be gone. This makes it more likely that users will view more of the advertisements contained in the content item, especially those present towards the end of the content item. This makes those last advertising slots more attractive than in the prior art.

In an embodiment the method further comprises asking the user to press a particular button during or after the rendering of the at least one advertisement and confirming if the user presses the particular button within a predetermined time interval after the asking. The pressing of the button now serves as an explicit confirmation by the user. Since it is the advertisement that directs him to press the particular button, it follows that the user must have actively viewed the advertisement and so he can be awarded the credit.

In a further embodiment the at least one advertisement comprises a portion being rendered only upon an explicit user action, and confirming comprises the complete rendering of said portion. For example in an interactive television system a textual or graphical advertisement may be shown on the display. The user can click on the displayed text or graphic, upon which a commercial is shown. This can be for instance a 1 O-seconds movie that gives more detail about the advertised product, including information on where to buy it. Additionally, clicking on the graphic may take the user to the advertiser's website.

In a further embodiment the method further comprises invalidating any awarded credits upon completion of the rendering of the content item. As explained above, the additional content material will be gone after the rendering of the content item is complete. This gives users an incentive to collect a sufficient number of credits to access the additional content material. However, if after the completion of the rendering not only the additional content material, but also the awarded credits themselves are lost, users will have an even greater incentive to collect a sufficient number to access the additional content material.

It is a further object of the invention to provide a device according to the preamble, which is more effective than the prior-art device.

This object is achieved according to the invention in a device which is characterized by conditional access means for giving the user access to additional content material associated with the content item in return for a number of awarded credits. Because the conditional access means prevents access to the additional content material without the required number of credits, this device encourages users to collect credits by actively viewing advertisements presented during the rendering of the content item. Preferably, the device comprises a television.

The invention further relates to a computer programmed product arranged for causing a processor to execute the method according to the invention.

These and other aspects of the invention will be apparent from and elucidated with reference to the embodiments shown in the drawings, in which:

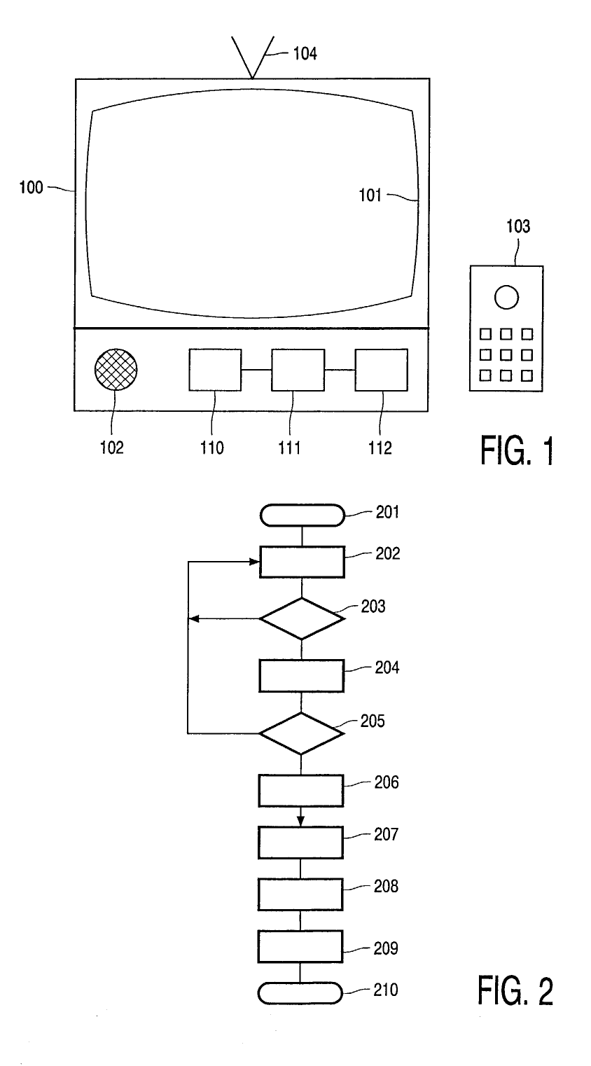

FIG. 1 schematically shows an embodiment of a device according to the invention,

FIG. 2 shows a flow chart illustrating the method according to the invention.

Throughout the Figures, same reference numerals indicate similar or corresponding features. Some of the features indicated in the drawings are typically implemented in software, and as such represent software entities, such as software modules or objects.

FIG. 1 schematically shows a device 100 arranged for rendering a content item. The device 100 is shown here as a television, but may also be a radio, a personal computer, or a hand held device such as a mobile telephone. The exact way in which a content item is rendered depends on the type of device and the type of content. For instance, in a radio receiver, rendering comprises generating audio signals and feeding them to loudspeakers. For a television receiver, rendering comprises generating audio and video signals and feeding those to a display screen and loudspeakers. For other types of content, a similar appropriate action must be taken. Rendering may also include operations such as decrypting or descrambling a received signal, synchronizing audio and video signals and so on.

The device 100 comprises a display 101 and a loudspeaker 102 for outputting video and audio, respectively. Using an input device 103 such as a remote control, the user can navigate between the available content items and choose one for rendering. The content items may be received from an external source e.g. through antenna 104, but may also be available from a local source such as a video or DVD player connected to the device 100. Some or all of the available content items will contain advertisements. These advertisements may be displayed as part of the content item, for example a short audio and/or video clip between portions of the content item being displayed. The advertisement may also be incorporated in the content item in other ways. For example a graphical advertisement can be presented in a corner of the display 101, a textual message can be presented in a scrolling fashion over the display 101, an audio message can be mixed with the normal audio signal being output over the loudspeaker 102, and so on.

The advertisements may be contained in the content item as a part of the audio and/or video portions of that content item, as is the case with traditional television and radio programming, but may also be contained as a separate data stream. In particular, an MPEG coding of the content would be well suited for this invention. The advertisements could then be present in a separate data stream that is multiplexed with the audio and video streams that make up the content item to form a transport stream that can be transmitted to the device 100. The additional content material could also be present in a separate data stream that is part of the transport stream.

When the advertisements are included separately, the device 100 can decide when, where and how to present the advertisement during the rendering of the content item. Rendering of advertisements can then be made optional. For example, users can be offered a choice between a paid mode in which no advertisements are shown, and a free mode in which no money needs to be paid for accessing the content items, but in which advertisements are shown. Alternatively, the number of advertisements in the paid mode can be severely reduced with respect to the number of advertisements in the free mode. Many variations on this theme are possible.

Also, advertisement substitution can be performed. Based on a user profile of some kind, an advertisement that is suited to the user can be displayed. For example, the advertisement shown can be in the language that the user speaks, or can be modified from a beer commercial to a fashion commercial if the user is female.

In accordance with the invention, the device 100 comprises a confirmation module 110, a credit module 111 and a conditional access module 112. The confirmation module 110 operates while advertisements are being presented in order to confirm that the user has observed the advertisement. Upon confirmation, the confirmation module 110 signals this fact to the credit module 111, so that the credit module 111 awards the user a credit for said observing. Of course the number of credits for a particular advertisement may be more than one and needs not be the same for all advertisements contained in the content item. When enough credits have been collected, conditional access module 112 gives the user access to additional content material associated with the content item being rendered. After giving access, the conditional access module 112 signals the credit module 111 to subtract said number of awarded credits from the credits that the user has collected.

FIG. 2 shows a flowchart illustrating an embodiment of the method according to the invention. The method starts at step 201. It may be necessary to perform some kind of initialization, to download some data and so on. At step 202, a content item is being rendered to the user. As explained above, this may involve displaying graphics, producing audio and/or video output, or both. The content item being rendered contains at least one advertisement.

When the advertisement is being rendered, at 203 a decision is made whether actively viewing this advertisement should be rewarded with a certain number of credits. If not, the method returns to step 202 and may return to step 203 at the next advertisement being rendered. It may be desirable to let only a subset of the advertisements in the content item be advertisements which result in credits being awarded for active viewing. The space for the advertisements in that subset could then be sold to advertisers at a higher rate.

If actively viewing the advertisement does result in a credit being awarded, then at step 204 the user's behavior is monitored to determine whether he is actively viewing the advertisement. This can be done in a variety of ways. For example, the user can be asked to press a particular button during or after the rendering of the advertisement. If he does so within a predetermined time interval after the asking, for example five seconds, then it can be assumed that the user was actively viewing the advertisement.

The user can also be asked to place a smart card in a receiver connected to the device 100, which receiver is arranged to eject the card after one or more advertisements have been rendered. This way the user has to re-insert the smart card for every advertisement or group of advertisements, and so it is likely that he is actively viewing the advertisements. The credits can then be stored on the card.

The advertisement may also comprise a portion which is rendered only upon an explicit user action, such as pressing a button or clicking on another portion presently being rendered. For example, during rendering of a movie, a graphical advertisement is shown in a corner of the display 101. Using cursor keys or a jog wheel on his remote control 103, the user selects the graphical advertisement and presses a button. On a personal computer, the user would operate a mouse or a similar device to select a banner and be taken to the advertiser's homepage. This explicit user action then reveals that the user is actively viewing or interacting with the advertisement.

At the beginning of the rendering of the advertisement, the user may be prompted if he does want to see the advertisement or not. If he gives positive feedback, it can be assumed that he will be actively viewing the advertisement.

The determination whether the user is actively viewing the advertisement is made in step 205. It may be that the pressing of a button or other explicit user action is to be disregarded, for example, if it was made too quickly after the start of the rendering of the advertisement. This may be a signal that the user is not actively viewing the advertisement, but is trying to cheat the system. If the user was not actively viewing the advertisement, the method returns to step 202. If he was, then at 206 he is awarded a credit. A credit does not have to be one single unit and it does not have to be the same for all advertisements. Advertisements that are present more towards the end of the content item may be worth more credits than advertisements present more towards the beginning.

The awarded credits are added to a running total, maintained by credit module 111 as explained above. Having collected enough credits to access additional content material, at step 207 the user can activate the conditional access module 112 to request access to the additional content material. This material may comprise items such as a 3-D module of an object present in the content item, a game associated with the content item, background information on the content item, or a clue for a question posed in the content item. The additional content material may also be an enhanced version of the content item, for example at a higher resolution, with better sound and so on.

If the user has collected enough credits, then at 208 the conditional access module 112 grants access to the additional content material. During the time that the user is interacting with the additional content material, the rendering of the content item may or may not be suspended depending on the application.

For example, if the additional content material is a clue for answering a question posed in the content item or a clue for solving a puzzle presented in the content item, then it may be advantageous to not suspend rendering so as to impose a certain kind of penalty for using the clue.

When examining a 3-D module of an object pressed in the content item, such as a racing car taking part in a race being shown, or an airplane that is part of a show, it would be better to suspend rendering of the content item, e.g. by activating a time-shifting function, so that the user can pick up where he left in the movie or show.

The awarded credits can be used as a fixed fee with which access to the additional content material can be bought. The credits can also be used to pay for the time the user spends with the additional content material. For example with five credits the user can access some textual background material on the content item, and for a rate of one credit per thirty seconds the user can interact with the 3-D module of some object present in the content item.

When rendering of the content item is complete, any awarded credits that were collected during the rendering of the content items are invalidated in step 209. This can be realized by simply resetting the credit counter in credit module 111 to zero. Invalidating awarded credits is not strictly necessary, but it has the advantage that it encourages users to collect enough credits to access additional content material even more.

Alternatively, the credits may be tied specifically to the content item, so that they become useless after rendering is complete.

If the user switches to another content item before the rendering of the present content item has been completed, any awarded credits may also be invalidated. This way, it is prevented that the user can keep credits intact by switching to another content item before the end of the present one.

The method ends at 210. Of course, the method can be repeated for further advertisements contained in the content item, and various modifications to the above sequence can be made.

It is of course important to inform the user that additional content material is available. To this end, the content item being rendered may be provided with a special icon that is shown during the rendering. Also, advertisements whose active viewing will result in credits being awarded should also be specially marked so as to induce the user to actively view them.

The invention can be used in conjunction with traditional incentive schemes, in which credits having an arbitrary lifetime can be collected by actively viewing advertisements. In such a combination, actively viewing an advertisement could result in being awarded a credit with an arbitrary lifetime (for use with the traditional incentive scheme), or a credit having a lifetime no longer than the remaining rendering time of the content item, or both.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of rendering a content item containing at least one advertisement to a user, comprising confirming that the user has observed the at least one advertisement and awarding the user a credit for said observing, characterized by giving the user access to additional content material associated with the content item in return for a number of awarded credits.

2. The method of claim 1, further comprising asking the user to press a particular button during or after the rendering of the at least one advertisement and confirming if the user presses the particular button within a predetermined time interval after the asking.

3. The method of claim 1 or 2, wherein the at least one advertisement comprises a portion being rendered only upon an explicit user action, and confirming comprises the complete rendering of said portion.

4. The method of claim 1, further comprising invalidating any awarded credits upon completion of the rendering of the content item.

5. The method of claim 1, whereby the additional content material comprises at least one of: a 3-D model of at least one object present in the content item, a game associated with the content item, background information on the content item, and a clue for a question posed in the content item.

6. A device arranged for rendering a content item containing at least one advertisement to a user, comprising confirmation means for confirming that the user has observed the at least one advertisement and credit means for awarding the user a credit for said observing, characterized by conditional access means for giving the user access to additional content material associated with the content item in return for a number of awarded credits.

7. The device of claim 6, further comprising prompting means for asking the user to press a particular button during or after the rendering of the at least one advertisement and the confirmation means being arranged for confirming if the user presses the particular button within a predetermined time interval after the asking.

8. The device of claim 6, the conditional access means being arranged for invalidating any awarded credits upon completion of the rendering of the content item.

9. The device of claim 6, comprising a television.

10. A computer program product arranged for causing a processor to execute the method of claim 1.
